(19) United States
(12) Patent Application Publication
(10) Pub. No.: US 2006/0212626 A1
(43) Pub. Date: Sep. 21, 2006

(54) Independent hard disk control device

(75) Inventors: Chao-Pang Ting, Taipei (TW); Chung-Hua Chiao, Taipei (TW); Chun-Liang Lee, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/083,935

(22) Filed: Mar. 21, 2005

(51) Int. Cl. G06F 13/12

(52) U.S. Cl. 710/74

(57) ABSTRACT

An independent hard disk control device for linking a motherboard and a hard disk includes a first substrate, a first interface, a second interface and a hard disk controller. The first interface, second interface and hard disk controller are installed on the first substrate. The hard disk controller is connected to the first interface and the second interface. The hard disk has a third interface, which is connected to the first interface through a flat cable. The motherboard has a fourth interface, which is connected to the second interface. The hard disk controller controls signal and data transmission between the motherboard and the hard disk.

### BACKGROUND

1. Field of Invention

The present invention relates to a controller for data storage devices and particularly to an independent hard disk control device.

2. Description of the Related Art

Hard disks are standard and major data storage devices in data processing systems nowadays. With the advance of technology, the hard disk technology also has great improvements. The size of the hard disk shrinks constantly while the capacity increases greatly. To overcome the bottleneck of the hard disk technology in data transmission, various driving interface standards have been developed, such as IDE, SCSI, S-ATA, S-ATAII, ESDI, SAS, ST-506, and the like. Various hard disk controllers mating the interfaces also have been introduced to meet the requirements of the system for fast accessing data of the hard disk.

Referring to FIG. 1, a conventional electronic device (such as computers, servers, and the like) has a hardware controller 110 is connected to a hard disk driving bus 120 (such as IDE, SCSI, S-ATA, S-ATAII, ESDI, SAS or ST-506) and a first personal computer (PC) bus 130 (such as ISA, EISA, VL or PCI). The hard disk driving bus 120 is connected to a hard disk 210 through a flat cable 220.

When a request signal to access the hard disk flows into the first PC bus 130, the hardware controller 110 issues a hard disk control signal and performs data transmission between the hard disk driving bus 120 and the first computer bus 130.

Moreover, there are a cache controller 140 and a cache memory 150 linked by a signal line 11 to transmit an address signal and a control signal there between. The cache controller 140 is connected to a second PC bus 132 (such as ISA, EISA, VL or PCI).

When the second PC bus 132 has a request signal to access the hard disk, the cache controller 140 outputs a cache control signal and a cache address signal through the signal line 11 to check whether there is a copy of data of the hard disk to be accessed, stored in the cache memory 150.

If the request signal is a read signal and the data requested by the read are stored in the cache memory 150, the cache controller 140 retrieves the desired data from the cache memory 150 and the data are transmitted to the main system via a third computer bus 134 (such as ISA, EISA, VL or PCI).

If the request signal is a read signal and the data requested by the read are not stored in the cache memory 150, the cache controller 140 generates a MISS signal, which is transferred to the hardware controller 110 through the second PC bus 132 and the first PC bus 130. The hardware controller 110 issues a hard disk control signal to retrieve data from the hard disk 210 through the hard disk driving bus 120, and the retrieved data are transmitted to the main system. The hard disk data in the data block, where the data reside, are written in the cache memory 150 through the hardware controller 110 and the first PC interface 130, by the control of the main system through the third PC bus 134, to facilitate fast access of the hard disk data next time.

For a writing data request, the data are written in the hard disk 210 through the first PC bus 130, hardware controller 110 and hard disk driving bus 120. Meanwhile, the cache controller 140 is controlled by the signal of the second PC bus 132, to check whether the writing block has a corresponding cache memory area in the cache memory 150. If positive, the signal line 11 issues an address and control signal, and the data on the third PC bus 134 are written in the cache memory 150 to update the data.

At present, the hardware controller 110, hard disk driving bus 120, PC buses 130, 132 and 134, cache controller 140, cache memory 150 and signal line 11 and the main system (not shown in the drawing) are installed on a same substrate 100, which is generally called the motherboard.

To ensure production quality and product safety, a product test is necessary either in the research and development stage or in production and manufacturing. After adding a device or function, tests must be done thoroughly again for each element and function, before the finished product is accepted.

As technology advances rapidly, and many types of driving interfaces for the hard disk have been used, such as IDE, SCSI, S-ATA, S-ATAII, ESDI, SAS or ST-506. However, the hard disk is connected to the hard disk controller having an interface matching the types of driving interface of the hard disk. Namely, the hard disk controller on the motherboard has to provide the same interface to link the hard disk. When the hard disk driving interface is changed due to the user's different requirements, the hard disk controller on the motherboard also has to be altered. And the hard disk controller has to be tested for each element and function. Moreover, other elements on the motherboard also have to be tested anew before the motherboard is shipped for sales. These repetitive tests consume a great deal of manpower and resources for the manufacturers. Hence how to reduce the test time to obtain a comprehensive test result is a main issue to increase production yield.

### SUMMARY

In view of the aforesaid problems, the primary object of the present invention is to provide an independent hard disk control device to overcome the problems occurring to conventional techniques.

The independent hard disk control device according to the invention can reduce shop floor test time.

The independent hard disk control device according to the invention also can improve signal quality.

To achieve the foregoing objects, the independent hard disk control device according to the invention is provided to connect with a motherboard and a hard disk and includes a first substrate, a first interface, a second interface and a hard disk controller. The first interface, the second interface and the hard disk controller are installed on the first substrate. The hard disk controller also is connected to the first interface and the second interface.

The hard disk has a third interface, which is connected to the first interface through a flat cable. The motherboard has a fourth interface connecting to the second interface. Hence signals and data can be transmitted between the motherboard and the hard disk through the hard disk controller.

The third interface has an interface standard selected from interface standards that include IDE, SCSI, S-ATA, S-ATAII, ESDI, SAS and ST-506, and the first interface has an interface standard corresponding to that of the third interface. The fourth interface has an interface standard selected from interface standards that include ISA, EISA, VL and PCI, and the second interface has an interface standard corresponding to that of the fourth interface.

In addition, the motherboard and the first substrate may be stacked in an up and down manner to couple the fourth interface and the second interface together.

### BRIEF DESCRIPTION OF THE DRAWINGS

These and other features, aspects, and advantages of the present invention will become better understood with regard to the following description, appended claims, and accompanying drawings where:

FIG. 1 shows the system architecture of a conventional hard disk controller; and

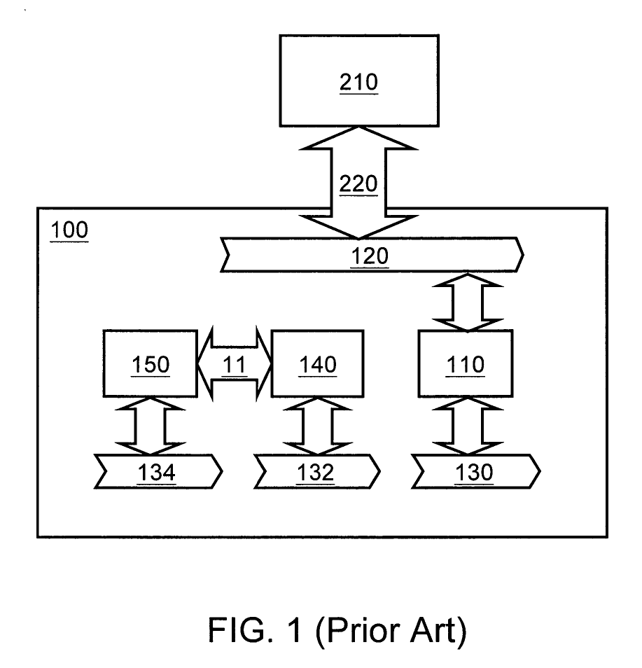

FIG. 2 shows the system architecture of an embodiment of the independent hard disk control device of the invention.

### DESCRIPTION OF THE PREFERRED EMBODIMENTS

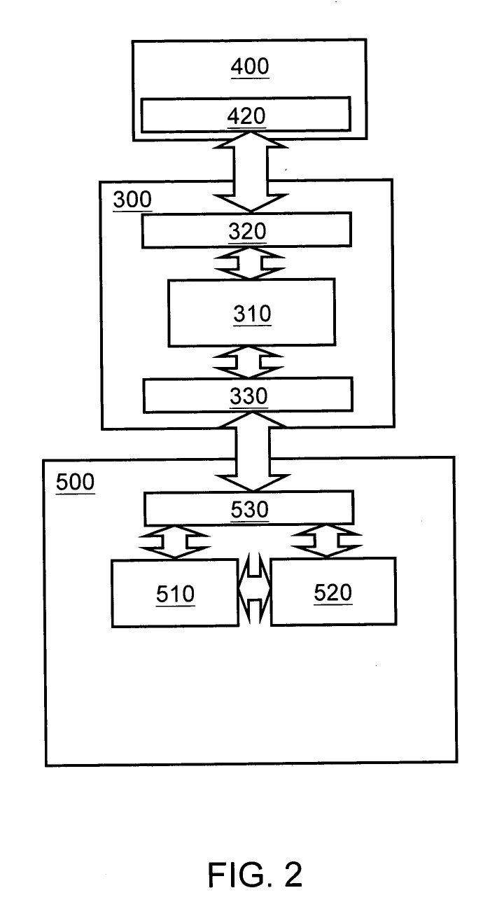

Refer to FIG. 2 for an embodiment of the independent hard disk control device of the invention. It includes a hard disk controller 310 installed on a first substrate 300 and connected to a first interface 320 and a second interface 330 through a signal line. The first interface 320 is connected to a hard disk 400 through a flat cable. The hard disk 400 has a third interface 420 connecting to the first interface 320 through the flat cable to transmit signals and data.

The second interface 330 may be coupled with a fourth interface 530 installed on a second substrate 500, or connected to the fourth interface 530 through another flat cable. The second substrate 500 has a cache controller 510 and a cache memory 520. The cache controller 510, cache memory 520 and fourth interface 510 are interconnected through signal lines.

When the main system (not shown in the drawing) on the second substrate 500 issues a request signal to access the hard disk, the signal is transferred to the hard disk controller 310 through the fourth interface 530 and the second interface 330. Then the hard disk controller 310 issues a hard disk control signal to the first interface 320 so that data are transmitted between the hard disk 400 and the second substrate 500.

Moreover, the hard disk access request signal also is transmitted to the cache controller 510. Then the cache controller 510 issues a cache control and cache address signals to the cache memory 520, to check whether a copy of the data to be accessed is stored in the cache memory 520.

If the access request signal is for retrieving and the data to be retrieved are stored in the cache memory 520, the cache controller 510 retrieves the access data from the cache memory 520 and transmits to the main system.

If the access request signal is for retrieving and the data to be retrieved are not stored in the cache memory 520, the cache controller 510 generates a MISS signal which is transferred to the hard disk controller 310 through the fourth interface 530 and second interface 330, and the hard disk controller 310 issues a hard disk control signal to retrieve data from the hard disk 400 through the linking first interface 320 and third interface 420, and the retrieved data are transmitted to the main system through the linking second interface 330 and fourth interface 530. Meanwhile, the hard disk data also are written in the cache memory 520 through the control of the main system to facilitate fast retrieval of the hard disk data next time.

If the access request signal is a writing request, the data to be written are written in the hard disk 400 through the linking second interface 330 and fourth interface 530, the linking first interface 320 and third interface 420, and the hard disk controller 310. Meanwhile, the cache controller 510 checks whether the cache memory 520 has a cache memory area corresponding to the writing data. It positive, a signal address and a control signal are sent to the cache controller 510 to rewrite the data in the cache memory 520 to update the data.

The third interface is selected from driving interface standards that include IDE, SCSI, S-ATA, S-ATAII, ESDI, SAS and ST-506. The first interface corresponds to one of the driving interface standards that include IDE, SCSI, S-ATA, S-ATAII, ESDI, SAS and ST-506. The fourth interface is selected from interface standards that include ISA, EISA, VL and PCI, while the second interface corresponds to one of the interface standards that include ISA, EISA, VL and PCI.

In addition, the first substrate and the second substrate may be coupled together by stacking, to shrink the total size to conform to the now prevailing miniaturization trend. Moreover, as the hard disk controller is installed independently on the first substrate, more signal tracks may be formed to improve signal quality. The second substrate may be a motherboard. The hard disk controller may be a hard disk control chip set.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. An independent hard disk control device for connecting to a motherboard and a hard disk, comprising:
a first substrate;
a first interface installed on the first substrate and electrically connecting with the hard disk;
a second interface installed on the first substrate and electrically connecting with the motherboard; and
a hard disk controller installed on the first substrate and connecting with the first interface and the second interface to transmit signals and data between the motherboard and the hard disk.

2. The independent hard disk control device of claim 1, wherein the hard disk has a third interface which is connected to the first interface through a flat cable.

3. The independent hard disk control device of claim 2, wherein the third interface has one of interface standards which include IDE, SCSI, S-ATA, S-ATAII, ESDI, SAS and ST-506, and the first interface has an interface standard corresponding to the interface standard of the third interface.

4. The independent hard disk control device of claim 1, wherein the motherboard has a fourth interface which is connected to the second interface.

5. The independent hard disk control device of claim 4, wherein the fourth interface has one of interface standards which include ISA, EISA, VL and PCI, and the second interface has an interface standard corresponding to the interface standard of the fourth interface.

6. The independent hard disk control device of claim 4, wherein the motherboard and the first substrate are stacked up in an up/down manner, so that the fourth interface is coupled with the second interface.

7. The independent hard disk control device of claim 1, wherein the hard disk controller is a hard disk controlling chip set.
